(19) United States
(12) Patent Application Publication
(10) Pub. No.: US 2023/0313895 A1
(43) Pub. Date: Oct. 5, 2023

(54) OIL PRESSURE REGULATOR VALVE

(71) Applicant: Ernest Lambert Nelson, Thief River Falls, MN (US)

(72) Inventor: Ernest Lambert Nelson, Thief River Falls, MN (US)

(21) Appl. No.: 18/153,627

(22) Filed: Jan. 12, 2023

Related U.S. Application Data
(60) Provisional application No. 63/326,050, filed on Mar. 31, 2022.

(51) Int. Cl. F16K 15/02; G05D 16/06

(52) U.S. Cl. CPC F16K 15/025; G05D 16/0636

(57) ABSTRACT

An oil pressure regulator valve assembly includes a cap comprising a polygonal section and a passage along an axis. A stem is at least partially telescoped into the passage along the axis; and a spring that biases the stem with respect to the cap.

The present disclosure claims priority to United States Provisional Patent Disclosure Ser. No. 63/326,050 filed Mar. 31, 2022.

### BACKGROUND

The present disclosure relates to a valve, and more particularly to an oil pressure regulator valve for a parallel twin engine.

A parallel twin engine is any engine with two cylinders which share one cylinder head. Typically, in a parallel twin, both pistons move up and down at the same time. So when moving up, one is compressing, while other is doing exhaust; when moving down, one is doing combustion, while the other is doing intake. Oftentimes, such engines may have oil pressure issues.

### SUMMARY

An oil pressure regulator valve assembly according to one disclosed non-limiting embodiment of the present disclosure includes a cap comprising a polygonal section and a passage along an axis; a stem at least partially telescoped into the passage along the axis; and a spring that biases the stem with respect to the cap.

A further embodiment of any of the foregoing embodiments of the present disclosure includes, wherein the cap comprises an nipple section that extends from the polygonal section along the axis, the passage extends into the extended section.

A further embodiment of any of the foregoing embodiments of the present disclosure includes, wherein the polygonal section forms a hexagon.

A further embodiment of any of the foregoing embodiments of the present disclosure includes, wherein the cap is manufactured of brass.

A further embodiment of any of the foregoing embodiments of the present disclosure includes, wherein the stem comprises a plunger section, the plunger section of a diameter greater than a diameter of the stem.

A further embodiment of any of the foregoing embodiments of the present disclosure includes, wherein the passage is 60% the length of the stem.

A cap for an oil pressure regulator valve assembly according to one disclosed non-limiting embodiment of the present disclosure includes a polygonal section; and a nipple section that extends from the polygonal section along an axis, the passage extends into the nipple section along the axis.

A further embodiment of any of the foregoing embodiments of the present disclosure includes, wherein the polygonal section forms a hexagon.

A further embodiment of any of the foregoing embodiments of the present disclosure includes, wherein the cap is manufactured of brass.

A further embodiment of any of the foregoing embodiments of the present disclosure includes a threaded section that extends from the polygonal section along the axis.

A further embodiment of any of the foregoing embodiments of the present disclosure includes, wherein the threaded section comprises a M10X1.5 thread.

A further embodiment of any of the foregoing embodiments of the present disclosure includes, wherein the passage is 0.191 inches in diameter for a depth of 1.5 inches.

A further embodiment of any of the foregoing embodiments of the present disclosure includes, wherein the diameter of the stem is between 0.980%-0.983% the diameter of the passage.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is an exploded view of an oil pressure regulator valve according to one disclosed non-limiting embodiment.

FIG. 2 is a perspective view of an assembled oil pressure regulator valve.

FIG. 3 is a sectional view of a parallel twin engine with the oil pressure regulator valve installed therein.

### DETAILED DESCRIPTION

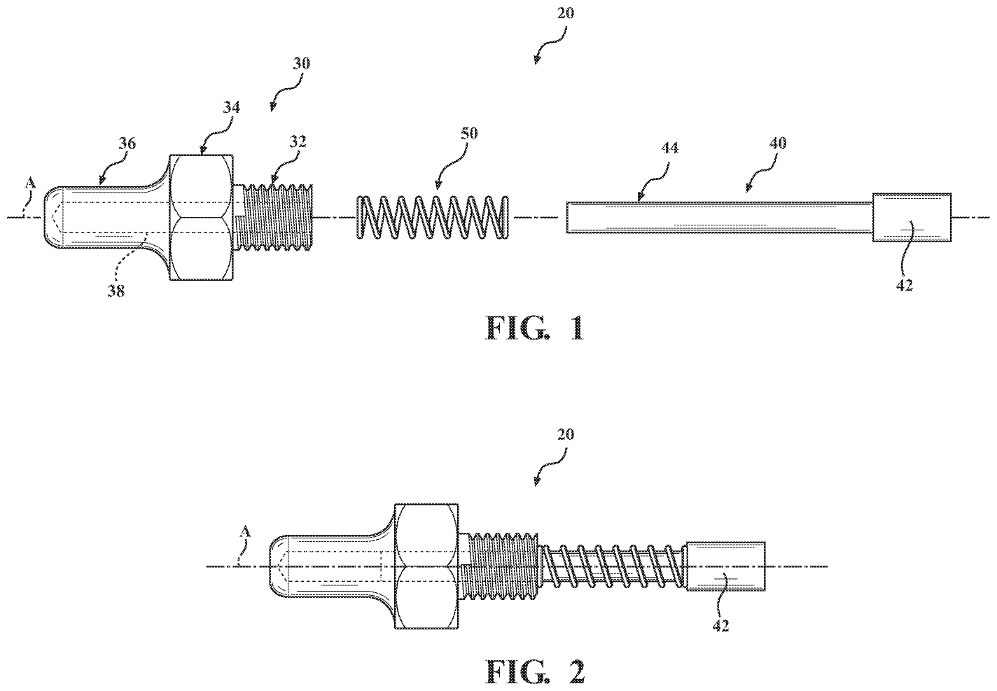

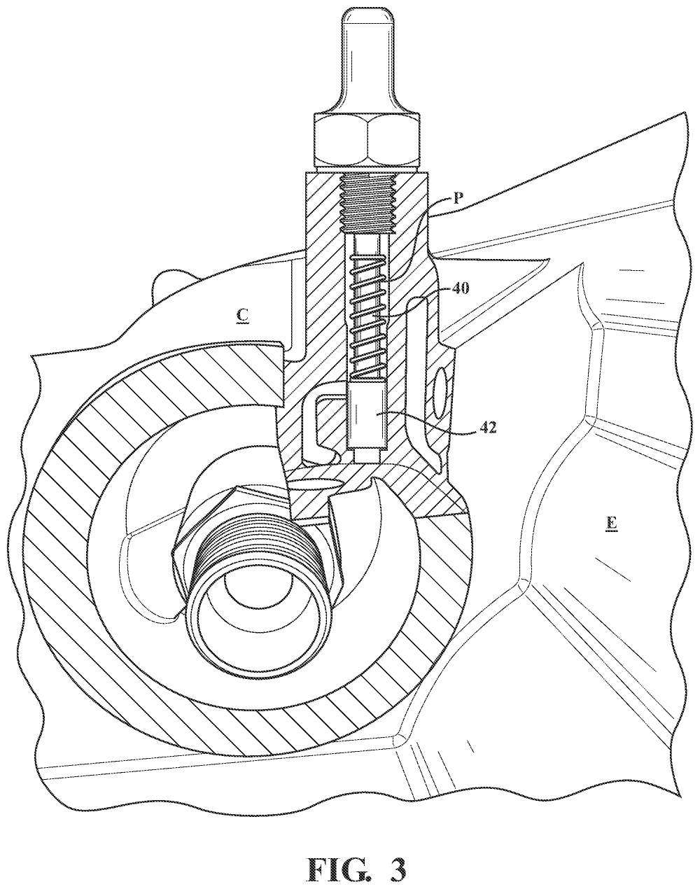

FIG. 1 schematically illustrates an oil pressure regulator valve assembly 20 for a parallel twin type engine. The oil pressure regulator valve assembly 20 includes a cap 30, a stem 40, and a spring 50. The stem 40 is telescoped into the cap 30 such that the stem 40 is biased along an axis A of the valve assembly 20 (FIG. 2). As the stem 40 is telescoped into the cap 30, a plunger section 42 of the stem 40 remains centered in a passage P formed in the crankcase C of the engine E (FIG. 3). The stem 40 may be manufactured of stainless steel to provide minimal expansion during operation. The spring 50, in contrast, may be manufactured of steel, rather than stainless steel to ensure no stainless welding occurs during operation.

The cap 30 includes a threaded section 32, an outer polygonal section 34, a nipple section 36, and a passage 38 along axis A. The cap 30 may be manufactured of brass so as to be appropriate for an aluminum crankcase C. The threaded section 32 may be a M10X1.5 thread. The outer polygonal section 34 may be hexagonal to receive a 0.750 inch wrench to thread the threaded section 32 into the crankcase C.

The passage 38 is of a diameter to closely receive the stem 44 that is telescopically received therein. The passage 38 extends into the nipple section 36 which extends axially beyond the outer polygonal section 34. That is, the nipple section 36 is of a smaller diameter than that of the outer polygonal section 34 to reduce weight and potential vibratory issues. In the disclosed embodiment, the cap 30 is 1.6 inches in overall length and the nipple section 36 is 0.375 inches in length and 0.375 inches in diameter.

In the disclosed embodiment, the stem 44 is 0.1875+/−0.0003 inches in diameter and the passage 38 is 0.191 inches in diameter for a depth of 1.5 inches. The interface between the stem 44 and the passage is of such tight tolerances to minimize play during operation. The passage 38 is thereby 60% the length of the stem 44 to provide significant support when the stem 44 is telescoped therein. In this embodiment, the diameter of the stem 44 is between 0.980-0.983 the diameter of the passage 38.

In one embodiment, the plunger section 42 may be a separate component that is mounted onto the stem 44. Alternatively, the plunger section 42 may be integral to the stem 44. In the disclosed embodiment the stem 44 is 2.5 inches in length and the plunger section is 0.5 inches in length. The stem 44 and the plunger section 42 may be manufactured of steel.

The oil pressure regulator valve assembly 20 provides for stable oil pressure throughout the entire rpm range without oil pressure spikes. The oil pressure regulator valve assembly 20 is operable in new and worn crankcases and avoids the potential for becoming stuck in the crankcase.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed is:

1. An oil pressure regulator valve assembly, comprising:
a cap comprising a polygonal section and a passage along an axis;
a stem at least partially telescoped into the passage along the axis; and
a spring that biases the stem with respect to the cap.

2. The assembly as recited in claim 1, wherein the cap comprises a nipple section that extends from the polygonal section along the axis, the passage extends into the nipple section.

3. The assembly as recited in claim 2, wherein the polygonal section forms a hexagon.

4. The assembly as recited in claim 1, wherein the cap is manufactured of brass.

5. The assembly as recited in claim 1, wherein the stem comprises a plunger section, the plunger section of a diameter greater than a diameter of the stem.

6. The assembly as recited in claim 1, wherein the passage is 60% the length of the stem.

7. A cap for an oil pressure regulator valve assembly, comprising:
a polygonal section; and
a nipple section that extends from the polygonal section along an axis, a passage extends into the nipple section along the axis.

8. The cap as recited in claim 7, wherein the polygonal section forms a hexagon.

9. The cap as recited in claim 8, wherein the cap is manufactured of brass.

10. The cap as recited in claim 9, further comprising a threaded section that extends from the polygonal section along the axis.

11. The cap as recited in claim 10, wherein the threaded section comprises a M10X1.5 thread.

12. The cap as recited in claim 9, wherein the passage is 0.191 inches in diameter for a depth of 1.5 inches.

13. The cap as recited in claim 12, wherein the diameter of the stem is between 0.980-0.983 the diameter of the passage.
